(19) United States
(12) Patent Application Publication
(10) Pub. No.: US 2010/0216098 A1
(43) Pub. Date: Aug. 26, 2010

(54) Nutritional Food Level System

(75) Inventor: Baxter D. Montgomery, Houston, TX (US)

Correspondence Address: ARI PRAMUDJI;PRAMUDJI LAW GROUP, PLLC, 1800 BERING DRIVE, SUITE 540, HOUSTON, TX, 77057, US

(73) Assignee: The Johnsie and Aubary Montgomery Institute of Education and Medical Research (JAM Institute)

(21) Appl. No.: 12/710,346

(22) Filed: Feb. 22, 2010

Related U.S. Application Data
(60) Provisional application No. 61/154,296, filed on Feb. 20, 2009.

(51) Int. Cl. G09B 19/00

(52) U.S. Cl. 434/127

(57) ABSTRACT

A method of categorizing a food. The method includes receiving a description of a food and making a number of determinations about the food. The method determines whether the food is plant-based or animal-based, the extent in which the food is processed and the nutritional characteristics of the food. After making these determinations, the method categorizes the food to a food level between 0 and 10 based on whether the food is plant-based or animal-based, the food's extent of processing and the food's nutritional characteristics.

### RELATED APPLICATION

This application claims priority to U.S. provisional patent application Ser. No. 61/154,296, filed Feb. 20, 2009, titled NUTRITIONAL FOOD LEVEL SYSTEM, which is incorporated herein by reference.

### BACKGROUND

1. Field of the Invention

Implementations of various technologies described herein generally relate to classifying foods into food categories based on their nutritional characteristics.

2. Description of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Numerous food classification systems have been developed in order to categorize foods based on their nutritional properties. Examples of these classification systems include “food groups” and “food pyramids.” These food classification systems organize various types of foods based on the nutritional properties of the foods in order to develop models of optimum nutrition diets for humans.

### SUMMARY

Implementations of various technologies described herein are directed to a method for categorizing foods into a food level system. In one implementation, a method for categorizing a food may include receiving a description of a food and making a number of determinations about the food. The method may determine whether the food is plant-based or animal-based, the extent in which the food is processed and the nutritional characteristics of the food. After making these determinations, the method may categorize the food to a food level between 0 and 10 based on whether the food is plant-based or animal-based, the food's extent of processing and the food's nutritional characteristics.

In another implementation, a method for categorizing a food may include receiving a description of the food and receiving information pertaining to the food. The information may include whether the food is plant-based or animal-based, the extent in which the food is processed and the nutritional characteristics of the food. After receiving this information, the method may categorize the food to a food level between 0 and 10 based on whether the food is plant-based or animal-based, the extent of the food's processing and the food's nutritional characteristics.

Various implementations described herein are also directed to a method for displaying a list of foods that corresponds to a food level. The method may first receive a food level from a user and then determine a list of foods, recipes, meal plans, or combinations thereof that correspond to the food level. After determining the list of foods, recipes, meal plans, or combinations thereof, the method may display the list.

Various implementations described herein are also directed to a method for prescribing a diet for a patient. The method for prescribing a diet for a patient may include receiving a health condition of the patient and determining one or more food levels for the diet based on the health condition. After determining the food levels for the diet, the method may display the diet.

Various implementations described herein are also directed to a memory for storing data for access by a computer application being executed on a processor. The memory includes a data structure stored in the memory. The data structure includes a category level zero for foods that are plant-based and juiced, blended or steeped in water as a tea at a temperature less than 100° F.; a category level one for foods that are ripened, chopped, minced, frozen or pureed, have a glycemic index that is less than 55 and an aggregate nutrient density index greater than 90; a category level two for foods that are ripened, chopped, minced, frozen or pureed and have a glycemic index that is less than 70 or an aggregate nutrient density index less than 90; a category level three for foods that are ripened, chopped, minced, frozen or pureed and have a glycemic index greater than 70; a category level four for foods that are warmed, dried or dehydrated at a temperature less than 155° F., steamed for less than 4 minutes or boiled for less than 10 minutes; a category level five for foods that are warmed, dried or dehydrated at a temperature between 155° F. and 200° F., steamed for a duration between 4 minutes and 10 minutes or boiled for a duration between 10 minutes and 45 minutes; a category level six for foods that are baked and have up to 20% fat per unit serving, warmed, dried or dehydrated at a temperature the is greater than 200° F., steamed for more than 10 minutes or boiled for more than 45 minutes; a category level seven for foods that are animal-based that have a type of fish excluding shellfish, catfish or fish with substantial levels of contaminants or plant-based foods that have been baked and have greater than 20% fat per unit serving, have been jarred, poached, canned, or combined with one or more natural additives; a category level eight for foods that are wild game meats, a type of fish excluding shellfish, catfish or fish with substantial levels of contaminants that has been lightly steamed or poached for more than 8 minutes or plant-based foods that have been grilled, foods that include carbohydrates with white flour/rice, or foods that have one or more natural components removed from the plant-based foods; a category level nine for foods that are domestically raised animals including all other types of fish but excluding beef and pork, foods that include one or more dairy-processed foods or foods that include plant-based foods that have been sautéed or stir-fried; and a category level ten for all other foods.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a schematic diagram of a computing system in which the various techniques described herein may be incorporated and practiced.

FIG. 2 illustrates a flow diagram of a method for categorizing foods into a food level in accordance with one or more implementations of various techniques described herein.

FIGS. 3-6 illustrate a flow diagram of a method for categorizing foods into a food level based on their characteristics in accordance with one or more implementations of various techniques described herein.

FIG. 7 illustrates a schematic diagram of a food level system in accordance with implementations of various technologies and techniques described herein.

FIG. 8 illustrates a flow diagram of a method for prescribing a diet based on a food level system in accordance with one or more implementations of various techniques described herein.

FIG. 9 illustrates a flow diagram of a method for displaying a list of foods, recipes and food plans that correspond to a food level in accordance with one or more implementations of various techniques described herein.

FIG. 10 illustrates a chart indicating food levels and its corresponding health zones in accordance with one or more implementations of various techniques described herein.

FIGS. 11A-11B illustrate a schematic diagram of a data structure for a food level system in accordance with implementations of various technologies and techniques described herein.

### DETAILED DESCRIPTION

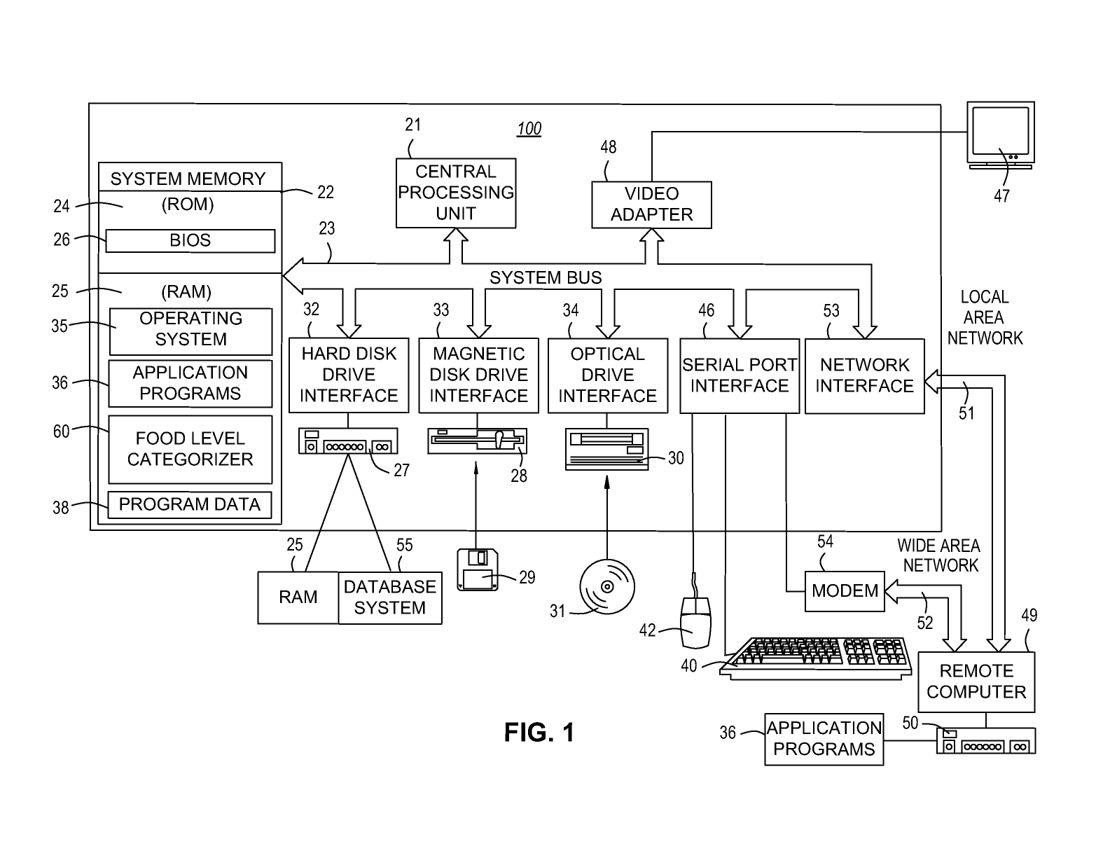

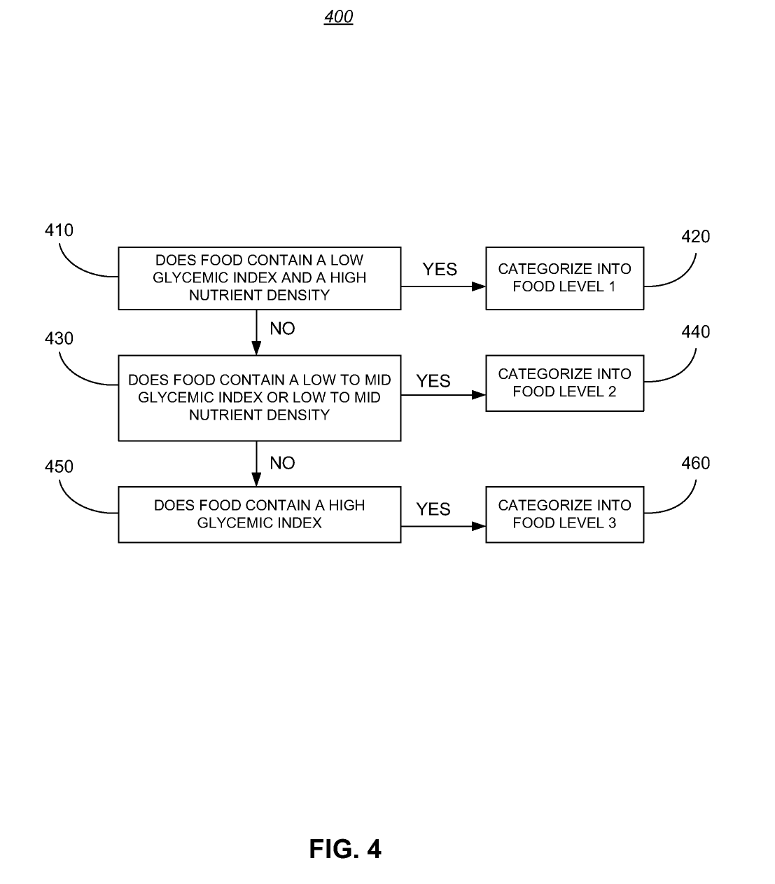

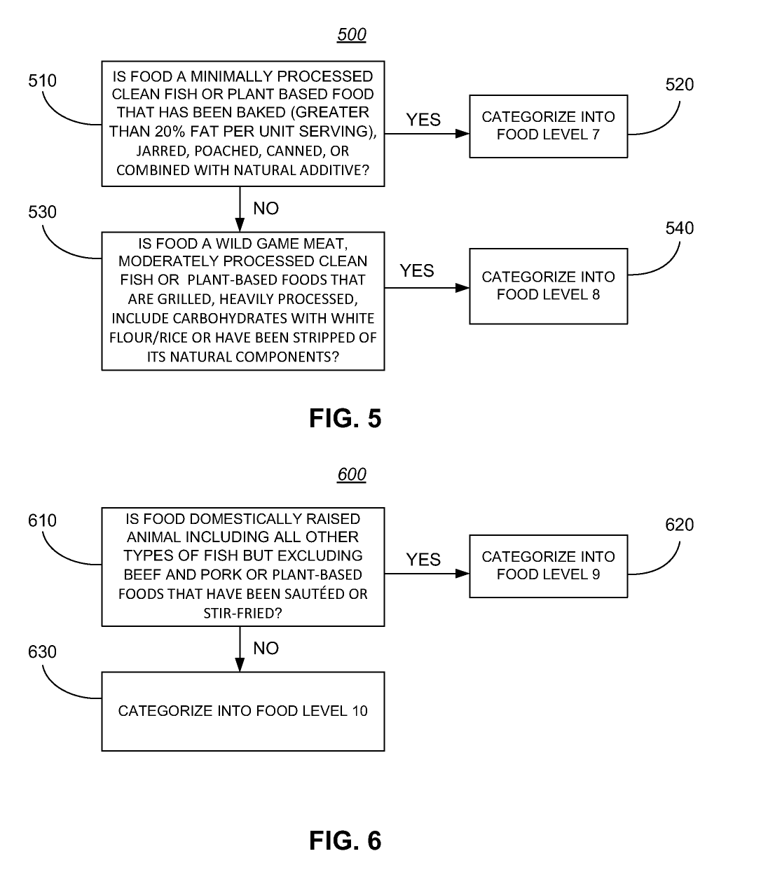

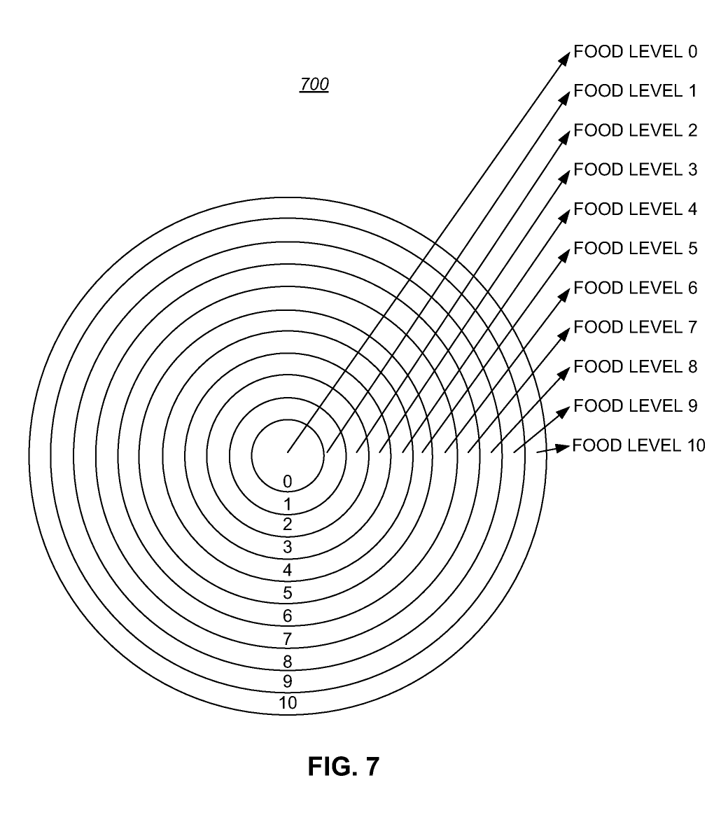

In general, one or more implementations described herein are directed to categorizing foods into food levels. Those implementations will be described in more detail with reference to FIGS. 1-11B.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

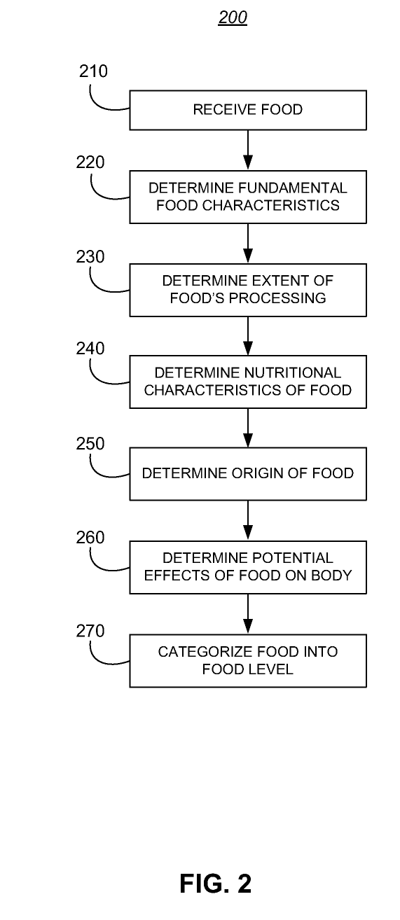

A number of program modules may be stored on the hard disk 27, magnetic disk 29, optical disk 31, ROM 24 or RAM 25, including an operating system 35, one or more application programs 36, program data 38, a food level categorizer 60 and a database system 55. The food level categorizer 60 will be described in more detail with reference to FIGS. 2-6 and 8-9 below. The operating system 35 may be any suitable operating system that may control the operation of a networked personal or server computer, such as Windows® XP, Mac OS® X, Unix-variants (e.g., Linux® and BSD®), and the like.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for categorizing foods into a food level in accordance with one or more implementations of various techniques described herein. The following description of method 200 is made with reference to computing system 100 of FIG. 1. It should be understood that while the operational flow diagram indicates a particular order of execution of the operations, in some implementations, certain portions of the operations might be executed in a different order. In one implementation, method 200 for categorizing foods into a food level may be performed by the food level categorizer 60.

At step 210, the food level categorizer 60 may receive a food description from a user. In one implementation, the food description may include a detailed list of all of the foods eaten during each meal for a time period, e.g., the previous month. In another implementation, the food description may include a detailed list of foods for each meal that the user may plan to consume during a time period, e.g., the upcoming month. Although a month has been given as an example for the time period, it should be understood that the time period can be any time period, such as a week, a day, a year, etc. In one implementation, the computer system 100 may include information pertaining to all types of foods in the database system 55. Such information may include fundamental characteristics of each type of food, an extent of processing of each type of food, nutritional characteristics of each type of food, and the potential effects of each type of food to a human body.

At step 220, the food level categorizer 60 may determine the fundamental characteristics of each food listed in the food description. The fundamental characteristics of a food may include whether the food is plant-based, animal-based or synthetic. Plant-based foods consists of only plants, animal-based foods includes any type of animal or meat, and synthetic foods include vitamins, supplements, cloned animal products and the like. Plant-based foods may be considered as superior to animal-based foods and animal-based foods may be considered as superior to or inferior to synthetic foods, e.g., a food additive such as an artificial dye will be inferior to fresh salmon, but a vitamin C supplement may be superior to a piece of fried chicken. Generally, animal-based and synthetic foods are considered to be inferior to plant foods by the food level categorizer 60. In one implementation, the fundamental characteristics of a food may be defined as “Food Classification Factor 1.” Food Classification Factor 1 may subcategorize foods as: A) Plant-based; B) Animal-based; or C) Synthetic. Food Classification Factors may be used to specify foods. For instance, a plant-based food may be classified as a 1A food and an animal-based food may be classified as a 1B food.

At step 230, the food level categorizer 60 may determine the extent in which each food listed in the food description is processed. The extent of processing of a food may be defined as “Food Classification Factor 2.” Food Classification Factor 2 may subcategorize foods into one of two categories: A) Physical and/or Chemical Change to the Food; or B) Extent of Mixing/Combining of the Food. Category A of Food Classification Factor 2 is further subcategorized into five groups. Group 1 includes: a) foods that have been juiced; b) foods that have been blended; c) foods that have been ripened; and d) foods that have been chopped. Generally, Group 1 is defined as including processed foods that may have beneficial effects from its processing.

Group 2 of Category A includes: a) foods that have been frozen; b) foods that have been warmed with a temperature less than 115° F.; c) foods that have been dried or dehydrated with a temperature less than 115° F.; d) foods that have been steamed for a short duration, i.e., less than 4 minutes; and e) foods that have been boiled for a short duration, i.e., less than 10 minutes. Generally, Group 2 is defined as including processed foods that may have neutral to mildly adverse effects from its processing.

Group 3 of Category A includes: a) foods that have been warmed with a temperature between 115° F. and 155° F.; b) foods that have been dried or dehydrated with a temperature between 115° F. and 155° F.; c) foods that have been steamed for a medium duration, i.e., between 4 and 10 minutes; and d) foods that have been boiled for a medium duration, i.e., between 10 and 45 minutes. Generally, Group 3 is defined as including processed foods that may have mild adverse effects from its processing with potentially greater adverse effects from its processing than processed foods in Group 2.

Group 4 of Category A includes: a) foods that have been warmed or baked with a temperature between 155° F. and 200° F.; b) foods that have been dried or dehydrated with a temperature between 155° F. and 200° F.; c) foods that have been steamed for a long duration, i.e., greater than 10 minutes; and d) foods that have been boiled for a long duration, i.e., greater than 45 minutes. Generally, Group 4 is defined as including processed foods that may have mildly adverse effects to likely adverse effects from its processing with more adverse effects from its processing than processed foods in Group 3.

Group 5 of Category A includes: a) foods that have been poached; b) foods that have been jarred; c) foods that have been canned; and d) foods that have been warmed, baked, dried or dehydrated with a temperature greater than 200° F. Generally, Group 5 is defined as including processed foods that are likely to have adverse effects from its processing with more adverse effects from its processing than foods in Group 4.

Group 6 of Category A includes: a) foods that have been sautéed or stir fried; b) foods that have been fried in a deep or shallow pan; c) foods that have been grilled; d) foods that have been microwaved; and e) foods that have used heat or chemical solvents to extract or separate components of a whole food, e.g., extracted vegetable oils. Generally, Group 6 is defined as including processed foods that are very likely to have adverse effects from its processing.

Category B of Food Classification Factor 2 may categorize foods as being a mono-food, pauci food or a complex food. Mono-food may include one ingredient, a pauci food may include five or fewer ingredients and a complex food may include more than five ingredients.

At step 240, the food level categorizer 60 may determine the nutritional characteristics of each food listed in the food description. The nutritional characteristics of a food may be defined as “Food Classification Factor 3.” Food Classification Factor 3 may subcategorize foods into one of five sublevels: 1) Glycemic Index of the food; 2) Nutrient Density of the food; 3) Phytonutrient, Vitamin and Mineral Content of the food; 4) Glycemic Load of the food; or 5) Macromolecular Profile of the food.

Sublevel 1 of Food Classification Factor 3 is further subcategorized into three groups: Group A, Group B and Group C. Group A of sublevel 1 includes foods that have a low glycemic index. In one implementation, low glycemic index foods have a glycemic index of less than 55. Group B includes foods that have a mid glycemic index. In one implementation, mid glycemic index foods have a glycemic index between 55 and 70. Group C includes foods that have a high glycemic index. In one implementation, high glycemic index foods have a glycemic index of more than 70.

Sublevel 2 of Food Classification Factor 3 is further subcategorized into two groups: Group A and Group B. Group A of sublevel 2 includes foods that have a high nutrient density. In one implementation, the nutrient density may be measured by the food's Aggregate Nutrient Density Index, which is described in more detail in Eat For Health, Book One; pgs. 51-55, by Fuhrman, Joel, M.D. In one implementation, foods that have a high nutrient density may include those foods that have an Aggregate Nutrient Density Index greater than 90. Group B of sublevel 2 includes foods that have a medium to low nutrient density. In one implementation, foods that have a medium to low nutrient density may include those foods that have an Aggregate Nutrient Density Index less than 90. Although the nutrient density of a food has been measured by an Aggregate Nutrient Density Index, it should be understood that in other implementations the nutrient density of a food may be measured by another type of measurement.

In one implementation, sublevel 3 may be a minor sub-factor or a subcomponent of sublevel 2. Similarly, sublevel 4 may be a minor sub-factor or a subcomponent of sublevel 1. Sublevel 5 may also be a minor sub-factor based on the percentage fats, carbohydrates and proteins in a food.

At step 250, the food level categorizer 60 may determine the origin or the development of each food listed in the food description. The origin or the development of a food may be defined as “Food Classification Factor 4.” Food Classification Factor 4 may subcategorize foods into one of three groups: A) Development in “Wild Conditions”; B) Naturally Cultivated; and C) Unnaturally Cultivated. Food Classification Factor 4 Group A foods may include those that are harvested from its, natural and wild conditions, which may be considered to be superior foods. Food Classification Factor 4 Group B foods may include those that are cultivated in organic conditions, which may be considered to be good foods. Food Classification Factor 4 Group C foods may include those that are unnaturally cultivated (i.e., with the addition of chemical preservatives for fertilizers or pesticides), which may be considered to be inferior foods.

At step 260 the food level categorizer 60 may determine the possible effects of the food on the body. Factor 5 may have three subcategories: A) Promotes Body Cellular, Tissue, and Organ Hydration, Alkalization, and Inflammation Reduction; B) Promotes Two of the Three (Hydration, Alkalization, and Inflammation Reduction); C) Promotes one or fewer of the three (Hydration, Alkalization, and Inflammation Reduction). Generally, foods that promote hydration, alkalization and reduce inflammation are considered to be superior foods. In one implementation, step 260 may be optional.

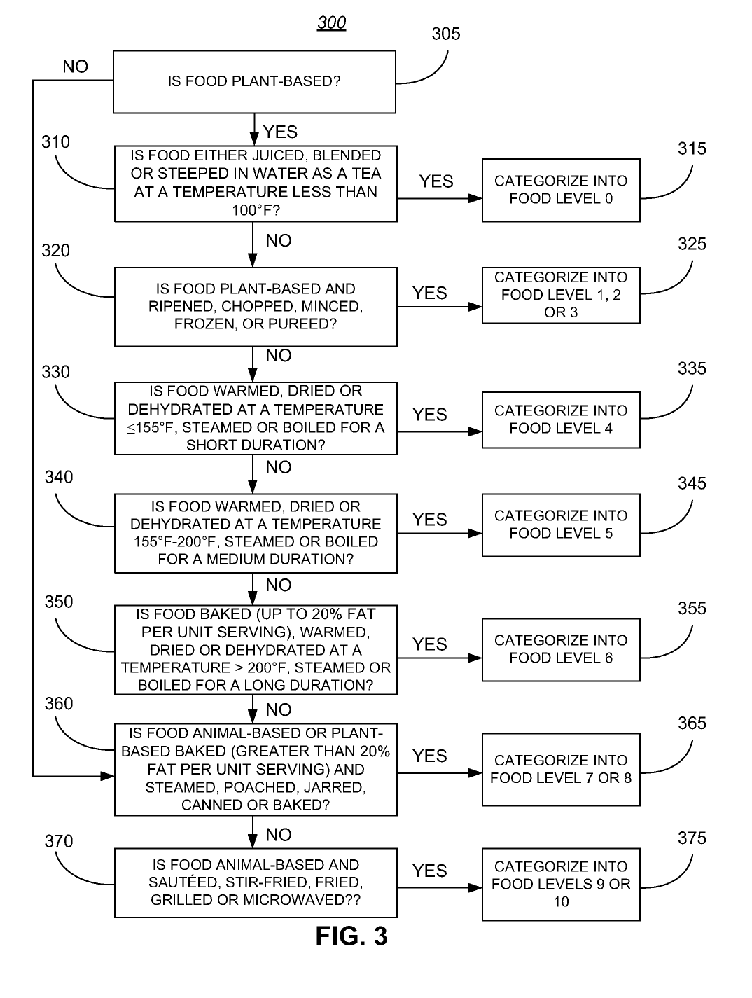

At step 270, the food level categorizer 60 may categorize each food listed in the food description into a food level in a food level system based on the fundamental food characteristics of the food, the extent of processing of the food, the nutritional characteristics of the food, the origin of the food and the food's possible effects on the body as determined in steps 220-260. The food level system may be a food classification scheme that consists of food levels 0 through 10. Each food level may denote a food type, preparation method, and a source of origin (e.g. harvested from the wild versus cultivated, cultivated organically versus conventionally, etc.). By convention, foods in the lower levels may be potentially more nourishing or healing than foods in the higher levels. The method for categorizing each food listed in the food description into a food level in a food level system based on the fundamental food characteristics of the food, the extent of processing of the food, the nutritional characteristics of the food and the origin of the food will be described in more detail in FIGS. 3-6 below.

FIGS. 3-6 illustrate flow diagrams of methods for categorizing foods into a food level based on their characteristics in accordance with one or more implementations of various techniques described herein. The following descriptions of method 300, method 400, method 500 and method 600 are made with reference to computing system 100 of FIG. 1 and method 200 in FIG. 2. It should be understood that while the operational flow diagram indicates a particular order of execution of the operations, in some implementations, certain portions of the operations might be executed in a different order. In one implementation, method 300, method 400, method 500 and method 600 for categorizing foods into a food level may be performed by the food level categorizer 60.

As mentioned above, the food level categorizer 60 may implement a food classification scheme that consists of food levels 0 through 10. Unlike traditional food classification schemes, this classification scheme may be designed to evolve over time with the development of sub-classification of the current levels as future research and knowledge dictates. The food level categorizer 60 may recommend foods considered to be optimal based on being minimally processed, whole and plant based foods. This classification scheme allows for the maximal flexibility in choice of food selection and preparation with the maintenance of optimal nutritional value.

At step 305, the food level categorizer 60 may determine whether the foods in the food description received at step 210 are plant-based. Foods that are plant-based are made up of only plants. If the food level categorizer 60 determines that the foods are plant-based, the food level categorizer 60 may proceed to step 310. At step 310, the food level categorizer 60 may determine whether the foods are juiced, blended or steeped in water as a tea at a temperature less than 100° F. based on the characteristics of the food determined by method 200. If the foods are juiced, blended or steeped in water as a tea at a temperature less than 100° F., the food level categorizer 60 may proceed to step 315. If, however, the foods are not juiced, blended or steeped in water as a tea at a temperature less than 100° F., then the food level categorizer 60 may proceed to step 320.

At step 315, the food level categorizer 60 may categorize the foods into Food Level 0. Food Level 0 may be the primary starting point or the core of all of the food levels. This level may consist of “live” foods in a liquid form. As such, Food Level 0 may theoretically contain live enzymes, proteins, minerals and other nutrients that are easily absorbed by the body with minimal energy expenditure. As an example, water may be considered to be a Food Level 0 food, even though it does not contain substances that are classically thought of as nutrients because it is a super nutrient itself. Other foods in Food Level 0 may include naturally fermented beverages from fruits and vegetables, freshly blended fruits and vegetables (e.g., in the form of fruit and vegetable smoothies), freeze-dried or dehydrated foods at a temperature that is less than 100° F. reconstituted in water. In theory, Food Level 0 food consumption would allow for the body to be nourished in an energy conservative manner. Foods consumed in an energy-conservative manner are those whose nutrients are easily absorbed by the body. For example, nutrients are more easily absorbed by the body from liquids, rather than solids. Therefore, liquids may allow for maximal cleansing and rebuilding of body cells and tissues. In one implementation, juices in Food Level 0 are juiced fresh without pasteurization.

Examples of foods in Food Level 0 include:

### Miscellaneous Beverages:

Water
Raw Lemonade (15 oz. of unpasteurized lemon juice/1 to 1½ cups Agave Nectar/dilute to one gallon)
Apple Cider Vinegar
Kombucha
Liquid Blue-Green Algae
Organic Green Tea
Organic Black Tea
Organic, non-boiled, herbal tea
   Basic Vegetable Juices: 16 oz. per serving
Carrot, beet (include beet tops)
Carrot & celery with tops
Carrot, apple & celery
Carrot, cucumber, parsley, spinach
Carrot, celery, broccoli, garlic (1 clove or more to suit)
Carrot, celery, spinach, beet, cabbage, red pepper.
Carrot, red pepper, 1—chili pepper
Carrot, beet, parsley, ginger, garlic, 1-3 pieces of chili pepper

### Combination Juices:

Carrot & apple
Carrot, apple, ginger
Carrot, apple, broccoli
Apple, beet
Sweet potato, beet, apple
Fennel bulb, apple, ginger, mint
Pineapple, celery, apple
Cucumber, celery, apple, mint, parsley
Grapefruit, lemon, olive oil, cayenne, garlic
Pineapple, cucumber, apple
Carrot, beet, garlic, wheatgrass

### Fruit Juices:

Orange & grapefruit
Orange & strawberry
Orange, lime, strawberry
Apple, ginger, wheatgrass
Orange, pineapple, strawberry
Apple, strawberry, ginger

In one implementation, the food level categorizer application 60 may use the Food Classification Factors described in FIG. 2 to further define particular types of foods within a Food Level. For example, a food, such as blue-green algae, Aphanizomenon flos-aqua (E3-live) in its liquid form, has a glycemic index (GI) of less than 50, which means that it is a Food Classification Factor 3-1A food. The blue-green algae also have a high nutrient density which means that it is also a Food Classification Factor 3-2A food. If the blue-green algae are harvested from its wild, natural environment it is also a Food Classification Factor 4A food. Using these Food Classification Factors, the food level categorizer application 60 may classify the blue-green algae as a Level 0 AAA food. Organic raw pineapple juice (with a glycemic index greater than 70 and a medium nutrient density) would be a Level 0 CBB.

Referring back to step 310, if the foods are not juiced, blended, or steeped in water as a tea at a temperature less than 100° F., the food level categorizer 60 may proceed to step 320. At step 320, the food level categorizer application 60 may determine whether the foods are in their raw state. In one implementation, foods in their raw state include foods that have been ripened, chopped, minced, frozen, or pureed. If the foods have these characteristics, the food level categorizer 60 may proceed to step 325. If, however, the foods do not have these characteristics, the food level categorizer 60 may proceed to step 330.

At step 325, the food level categorizer 60 may categorize the foods into Food Level 1, 2 or 3. Food level 1 may consist of raw foods in a solid state that are very nutrient dense and with a low glycemic index. Vegetables in this group may have dark, rich colors and may be very low in fat and starch. Sprouts, brightly colored berries, grapes and cruciferous vegetables (that do not have dark rich colors) may also be part of Food Level 1 because of their high nutritional density. In one implementation, foods in this state are prepared and eaten in their “raw” state. Examples of foods in Food Level 1 include:

### Acai Berries

### Alfalfa Sprouts

### Algae

### All Types of Peppers (Bell Peppers, Jalapeno Peppers, Paprika, Cayenne Peppers, etc.)

### Arugula

### Bean Sprouts

### Blue Berries

### Black Berries

### Bok Choy

### Broccoli Sprouts

### Broccoli

### Broccolini (Asparition)

Brussels sprouts
Cabbage (red or green)

### Cauliflower

### Celery

Chinese cabbage
Collard greens

### Daikon

### Chives

### Dandelion

Herbs (dried or fresh)

### Kale

### Kohlrabi

Mustard greens

### Radishes

### Rutabaga

### Garlic

### Leeks

Mushrooms (raw)

### Onions

### Shallot Sea Vegetation (Sea Weed)

### Turnips

### Watercress

### Goji Berries

### Plums

### Pomegranate Seeds

### Raspberries

### Strawberries

Vinegars (all other than apple cider)
Welsh onion (Green onion)

Food Level 2 foods may include foods that have a medium to low glycemic index or a medium to low nutrient density. In one implementation, foods in this level may be considered “non-grains”. Examples of foods in Food Level 2 include:

### Cucumbers

### Squash

### Eggplant

### Tomatoes

### Corn

Sweet Potatoes (or yams)
Winter Squashes (pumpkin, butternut squash, acorn squash, etc.)

### Beets

### Carrots

### Zucchini

### Asparagus

### Green Beans

### Squash

Food Level 3 may consist of “raw” non-grain plant based foods that have a high glycemic index. Examples of foods in Food Level 3 include:

### Agave Nectar (Raw)

### Apples

### Apricot

### Celtic Sea Salt

Corn, raw, organic

### Dates

Himalayan Sea Salt (can also be part of a Food Level 1 vegetable soup)
Idaho Potatoes (raw, organic)

### Kiwi

### Nectarine

### Raisins

### Red Potatoes

### Watermelon

### Cantaloupe

### Pineapples

### Grapes

### Bananas

### Peach

### Pear

### Oranges

### Grapefruit

### Prunes

### Honeydew Melon

### Mangos

In order to determine which Food Level between Food Level 1, 2 or 3 the foods may be categorized into, the food level categorizer 60 may use method 400. At step 410, the food level categorizer 60 may determine whether the foods have a low glycemic index and a high nutrient density. A low glycemic index may include food that have a glycemic index that is lower than 55. A high nutrient density food may include foods that have an aggregate nutrient density index that is greater than 90. If the foods have a low glycemic index and a high nutrient density, the food level categorizer 60 may proceed to step 420. At step 420, the food level categorizer 60 may categorize the foods into Food Level 1.

Referring back to step 410, if the foods do not have a low glycemic index and a high nutrient density, the food level categorizer 60 may proceed to step 430. At step 430, the food level categorizer 60 may determine whether the foods have a low to mid glycemic index or a low to mid nutrient density. A low to mid glycemic index food may include foods that have a glycemic index between 0-70. The low to mid nutrient density foods may include foods that have an aggregate nutrient index that is less than 90. If the foods have these characteristics, the food level categorizer 60 may proceed to step 440. At step 440, the food level categorizer 60 may categorize the foods into Food Level 2. If, however, the foods do not have these characteristics, the food level categorizer 60 may proceed to step 450.

At step 450, the food level categorizer 60 may determine whether the foods have a high glycemic index. High glycemic index foods include foods that have a glycemic index that is greater than 70. If the foods have these characteristics, the food level categorizer 60 may proceed to step 460. At step 460, the food level categorizer 60 may categorize the foods into Food Level 3.

Referring back to step 320, if the foods are not in their “raw” state (i.e., ripened, chopped, minced, frozen, or pureed), the food level categorizer 60 may proceed to step 330. At step 330, the food level categorizer 60 may determine whether the foods are dried, dehydrated or warmed at a temperature less than 155° F., steamed or boiled for a short duration based on the characteristics of the foods determined by the method 200. A short duration for steaming foods includes a time that is less than 4 minutes, and a short duration for boiling foods includes a time that is less than 10 minutes. If the foods have these characteristics, the food level categorizer 60 may proceed to step 335. If, however, the foods do not have these characteristics, the food level categorizer 60 may proceed to step 340.

At step 335, the food level categorizer 60 may categorize the foods into Food Level 4. Food Level 4 foods include lightly steamed, soaked, sprouted, dehydrated/warmed fruits, vegetables, legumes/beans and grains (4 minutes or less for steaming and 10 minutes for boiling) or raw avocados. Examples of foods in Food Level 4 include:

Steamed or blanched (4 minutes or less) vegetables listed in Food Levels 1-3

### Black-eyed Peas

### Bragg's Aminos

Edamame (soy beans)

### Beans (Kidney, Red, Lima, Navy, Garbanzo, Soy) (Dried or Frozen)

### Split Peas

### Gluten Free Pasta Grade A/B Maple Syrup

### Olives

### Sundried Tomato Crackers

Avocados (raw)
Coconut Milk (raw, unpasteurized)

Referring back to step 330, if the foods are not dried, dehydrated or warmed at a temperature less than 155° F., steamed or boiled for a short duration, the food level categorizer 60 may proceed to step 340. At step 340, the food level categorizer 60 may determine whether the foods are warmed, dried or dehydrated at a temperature between 155° F. and 200° F., steamed or boiled for a medium duration based on the characteristics of the foods determined by method 200. A medium duration for steaming foods includes a time that is between 4 and 10 minutes, and a medium duration for boiling foods includes a time that is between 10 and 45 minutes. If the foods have any of these characteristics, the food level categorizer 60 may proceed to step 345. If, however, the foods do not have any of these characteristics, the food level categorizer 60 may proceed to step 350.

At step 345, the food level categorizer 60 may categorize the foods into Food Level 5. Food Level 5 may have an increased duration of steaming (between 4 minutes and 10 minutes) and boiling (between 10 minutes and 45 minutes) greens, beans and legumes, an increased cooking of starches including grains, bean or mixed vegetable soups that are boiled for up to 45 minutes, oven warmed (temperature between 155° F. and 200° F.) fruit and vegetables, foods having no cooked fats and foods with no extracted oil or nuts. In one implementation, Food Level 5 may not include high fat foods (i.e., foods with fat content of greater than 20% per unit caloric content) that are cooked at any time. Examples of foods in Food Level 5 include:

Warmed Sweet Potato (not white potatoes)

### Cooked Wild Rice

Cooked Oats (steel cut oats, minimally processed)
Cooked Brown Rice (not white rice)
Coconut Milk (canned or in “juice box”)

### Coconut Oil

### Coffee

Extra Virgin Olive Oil (first cold press, if heated becomes Food Level 8)

### Ezekiel Bread

### Gluten Free Pasta

### Non-Organic Tea

### Organic Bottled Tomato Sauce/Pasta Sauce

Quinoa (soaked, lightly blanched, or steamed)

### Rice Crackers

Sprouted Grain Bread (Ezekiel, Manna brand)

Referring back to step 340, if the foods are not warmed, dried or dehydrated at a temperature between 155° F. and 200° F., steamed or boiled for a medium duration, the food level categorizer 60 may proceed to step 350. At step 350, the food level categorizer 60 may determine whether the foods are baked and have up to 20% fat per unit serving, food that are warmed, dried or dehydrated at a temperature is greater than 200° F., steamed or boiled for a long duration. A long duration for steaming foods includes a time that is greater than 10 minutes, and a long duration for boiling foods includes a time that is greater than 45 minutes. If the foods have these characteristics, the food level categorizer 60 may proceed to step 355. If, however, the foods do not have these characteristics, the food level categorizer 60 may proceed to step 360.

At step 355, the food level categorizer 60 may categorize the foods into Food Level 6. Food Level 6 is the same as Food Level 5 except for the increased time of steaming and boiling. The steamed foods may be steamed more than 10 minutes and the boiled foods may be boiled more than 45 minutes. Food Level 6 may also include foods that are baked and have up to 20% fat per unit serving, food that are warmed, dried or dehydrated at temperatures greater than 200° F. Baked foods generally include foods that are oven heated at temperatures greater than 200° F. Food Level 6 may also include raw, organic nuts and seeds. The cooked foods at this level may be composed of less than 20% fat per unit serving. Food Level 6 may also include:

Baked Blue Corn Chips (organic, less than 20% fat by calorie)
Raw/Organic Brazil Nuts (raw)
Coffee (organic)

### Raw/Organic Flax Seeds

### Gluten Free Crackers

### Gluten Free Pancakes

### Gluten Free Waffles

### Raw/Organic Hemp Seeds

Oatmeal (standard processed)

### Raw/Organic Pecans

### Raw/Organic Pumpkin Seeds (Pepitas)

### Rice Crackers

### Raw/Organic Sunflower Seeds

### Raw/Organic Tahini

### Tamari

### Tempeh

### Tofu

### Vegetable Pasta

### Veggie Burgers

### Raw/Organic Walnuts

Referring back to step 350, if the foods are not baked and have up to 20% fat per unit serving, warmed, dried or dehydrated at a temperature greater than 200° F., steamed or boiled for a long duration, the food level categorizer 60 may proceed to step 360. At step 360, the food level categorizer 60 may determine whether the foods are animal-based foods or plant-based foods that have been baked and have greater than 20% fat per unit serving, have been poached, jarred, canned, grilled or baked based on the characteristics of the foods determined by method 200. If the foods have these characteristics, the food level categorizer 60 may proceed to step 365. If, however, the foods do not have these characteristics, the food level categorizer 60 may proceed to step 370.

At step 365, the food level categorizer 60 may categorize the foods into Food Level 7 or 8. Food Level 7 may add clean fish to Food Levels 0 through 5. Clean fish may include all types of fish except fish that are considered shellfish, catfish or a fish that is likely to have significant levels of mercury or other contaminants. The fish in Food Level 7 may be caught in the wild and may not be farm-raised. Also, the fish in Food Level 7 may be raw (e.g., sushi or sashimi), lightly steamed or poached for a duration of 8 minutes or less.

Food Level 7 may also include plant-based foods that have been moderately processed or have natural additives. Processed or heated vegetable oils or cooked foods with more than 20% oils or fat by calorie may also be included in Food Level 7. Synthetic foods considered to be neutraceutical agents with the addition of natural additives may also be included in Food Level 7. Examples of fish in Food Level 7 include:

Almond Milk (Boxed, pasteurized)

### Almonds

### Canned Beans

### Canned Olives

### Canned Tomato Sauce

### Coconut Milk Canned

### Corn Tortillas

### Egg Whites

### Fiber One®

### Gluten Free Brown Rice Pasta

### Raw Nut Milks

### Rice Milk

### Sardines

### Salmon

### Sesame Seeds

### Flounder

### Sole

### Soy Milk

### Trout

### Tilapia

### Veganaise

### Brown Rice

Food Level 8 is the same as Food Level 7 but it includes wild game meats, clean fish that is processed to a greater extent than described in Level 7, and plant-based foods that are grilled or heavily processed. Food Level 8 may also include carbohydrates with white flour/rice or natural foods that have been stripped of its natural components. Synthetic foods in Food Level 8 include pharmaceutical agents. Examples of foods in Food Level 8 include

### White Flour Tortillas

### Waffles

### White Bread

### White Flour Pastas

### Sourdough Bread

### Sports Drinks

### Soft Drinks

### Wild Game

In order to determine which Food Level between Food Level 7 or 8 the foods may be categorized into, the food level categorizer 60 may use method 500. At step 510, the food level categorizer 60 may determine whether the animal-based foods is a clean fish that is minimally processed (i.e., fish excluding shellfish, catfish or fish with significant levels of contaminants) and whether the plant-based foods have been baked, jarred, poached, canned or combined with natural additives. Minimally processed clean fish includes clean fish that is raw (e.g., sushi or sashimi), lightly steamed or poached for a duration of less than 8 minutes. If the foods have these characteristics, the food level categorizer 60 may proceed to step 520. At step 520, the food level categorizer 60 may categorize the foods into Food Level 7.

Referring back to step 510, if the foods do not include animal-based foods that is a minimally processed clean fish, or plant-based foods that are baked and have greater than 20% fat per unit serving, have been jarred, poached, canned, or combined with natural additives, the food level categorizer 60 may proceed to step 530. At step 530, the food level categorizer 60 may determine whether the animal-based foods are a wild game meat, a clean fish that is processed more than a clean fish in Food Level 7 and whether the plant-based foods are grilled, include carbohydrates with white flour/rice, or have been stripped of its natural components based on the characteristics of the foods determined by method 200. If the foods have these characteristics, the food level categorizer 60 may proceed to step 540. At step 540, the food level categorizer 60 may categorize the foods into Food Level 8. If, however, the foods do not have these characteristics, the food level categorizer 60 may proceed to step 370.

At step 370, the food level categorizer 60 may determine whether the animal-based foods include domestically raised animals excluding beef and pork and whether the plant-based foods are sautéed, stir-fried, fried, or microwaved based on the characteristics of the foods determined by method 200. The domestically raised animals may include all other types of fish (i.e., “unclean” fish) such as shellfish, catfish or a fish that is likely to have significant levels of mercury or other contaminants. If the foods have these characteristics, the food level categorizer 60 may proceed to step 375. At step 375, the food level categorizer 60 may categorize the foods into Food Level 9 or 10. Food Level 9 may include all domestically raised animals, such as chicken, lamb, goat and turkey except for pork and beef and plant-based foods that have been sautéed or stir-fried. Food Level 9 may also include dairy-processed foods. Examples of Food Level 9 foods include:

Cheese (all types, organic, free range)

### Chicken

### Cow's Milk (Organic)

### Goat

### Lamb

### Turkey

### Whole Wheat Bread

### Yoghurt

### Imitation Cheese

Food Level 10 may include all other types of animal-based foods and plant-based foods prepared in any way. Accordingly, Food Level 10 may include all other types of processed foods of any kind with any type of chemical preservative. Synthetic foods that may be considered to be pharmaceutical agents are listed below.

### Beef

### Cheerios®

Cheese (all types, non-organic)

### Clams

### Conventional Poultry, Lamb, Goat

Cow's Milk (non-organic)

### Crab

### Fried Foods of Any Kind

### Grape Nuts®

### Iodized Salt

### Lobster

### Oysters

### Pancakes

### Pork

### Shark

### Shrimp

Soda (diet or regular)

### Steak

### Sugared Cereals (Fruit Loops®, Luck Charms®, Cocoa Puffs®, etc.)

### Swordfish

### Tuna

### Whole Eggs (Cooked or Raw)

In order to determine between Food Level 9 or 10, the food level categorizer 60 may use method 600. At step 610, the food level categorizer 60 may determine whether the foods include domestically raised animals (including all other types of fish but excluding beef and pork), include dairy-processed foods or include plant-based foods that have been sautéed or stir-fried. If the foods have these characteristics, the food level categorizer 60 may proceed to step 620. At step 620, the food level categorizer 60 may categorize the foods into Food Level 9.

Referring back to step 610, if the foods do not include domestically raised animals (including all other types of fish but excluding beef and pork), dairy-processed foods or plant-based foods that have been sautéed or stir-fried, the food level categorizer 60 may proceed to step 630. At step 630, the food level categorizer 60 may categorize the foods into Food Level 10.

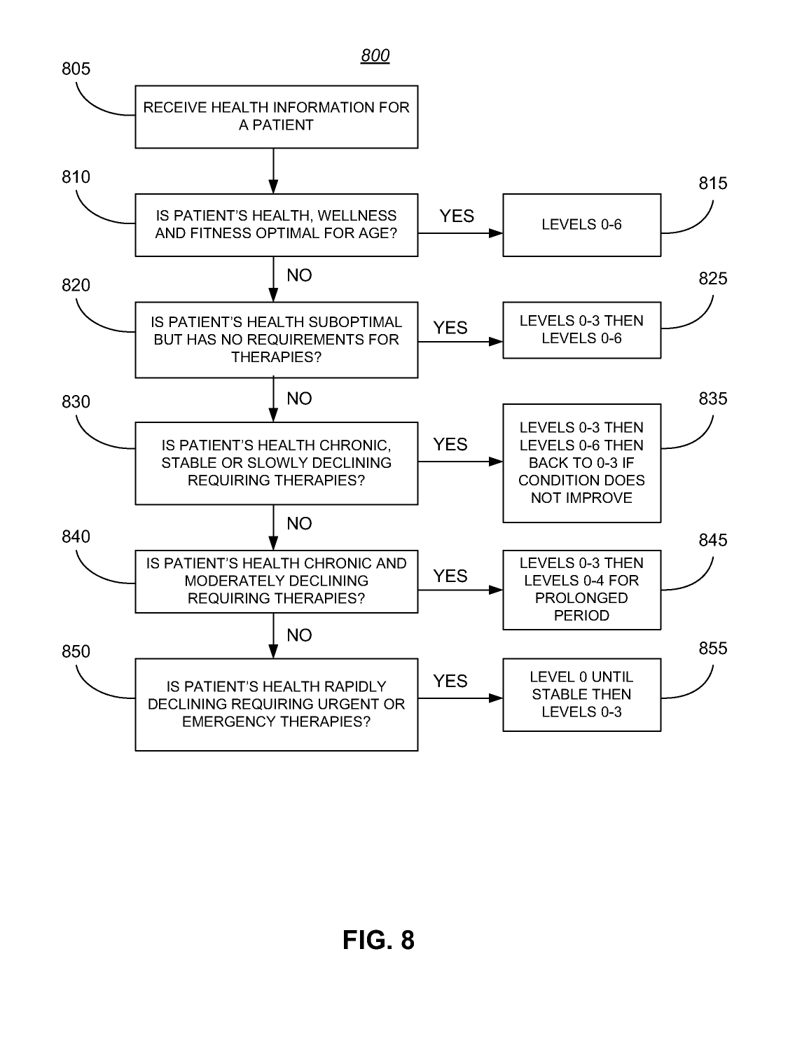

FIG. 7 illustrates a schematic diagram of a food level system in accordance with implementations of various technologies and techniques described herein. The following description of food level system 700 is made with reference to method 300, method 400, method 500 and method 600 in accordance with one or more implementations of various techniques described herein.

As indicated in FIG. 7, Food Level 0 makes up the center of the food level system 700. Food Level 0 is represented on the food level system 700 by the area in the circle of the food level system 700 having the smallest diameter. As such, very few foods may meet the Food Level 0 requirements.

The food level system 700 has ten concentric circles around the center circle (Food Level 0) such that each concentric circle has a larger diameter than its previous circle. Each subsequent food level may then be represented by the area between two adjacent concentric circles plus the area of the smaller adjacent concentric circle. The foods having only the properties of a corresponding food level may be represented in the area between two adjacent concentric circles. For example, foods in Food Level 1 may be represented in the area between the circle representing Food Level 0 and the adjacent concentric circle of Food Level 0. Accordingly, each subsequent food level encompasses its previous food levels. For example, Food Level 3 includes the Food Levels 0-2 as well. Therefore, Food Level 10 includes the most amounts of foods of all the food levels because it encompasses all of the food levels in the food level system 700.

The classification scheme described above in the food level system 700 may also be designed to be comprehensive such that the classification of foods into food levels may allow for foods to be considered to be beneficial, neutral, or detrimental for good health. Food level system 700 may also be used to serve as a visual status of how well a user has balanced recent meals, to help a user keep track of foods recently eaten, to suggest to a user which foods to choose for next meals, to encourage a user to have a variety of foods from different categories, and to promote a nutritional diet for a user. For example, foods classified in the central four circles may be considered most beneficial. Those in the middle circles may be considered moderately beneficial or at least neutral, and foods in the outer circles of the classification scheme may be considered as likely detrimental to good health.

The food level system 700 described above may be used to describe foods and other nutritional substances based on their ability to allow for optimal human bodily healing or function. As such, the potential uses for the food level system 700 include assisting healthcare professionals to prescribe nutritional regimens that would allow for disease prevention and/or reversal with fewer or no medications (medical), assisting individuals to allow for improvement in their overall fitness (health and wellness), assisting elected officials and policy makers to be better informed to set sound nutritional standards (public policy), assisting food producers, distributors and retailers in selecting foods of various nutritional levels (industry) and the like. For example, the food level system 700 may be used to prescribe foods according to a person's health needs or desires. As such, a patient in a hospital recovering from an illness or surgery may be prescribed foods from Food Level 0, which contains the most nourishing and healing foods.

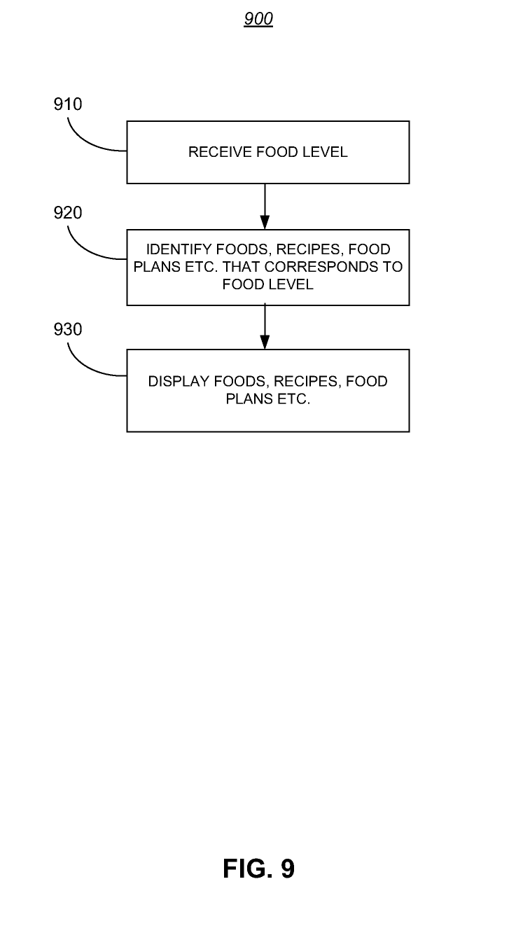

FIG. 8 illustrates a flow diagram of a method for prescribing a diet based on a food level system in accordance with one or more implementations of various techniques described herein. The following description of method 800 is made with reference to computing system 100 of FIG. 1 and the food level system 700 in FIG. 7. It should be understood that while the operational flow diagram indicates a particular order of execution of the operations, in some implementations, certain portions of the operations might be executed in a different order. In one implementation, method 800 for prescribing a diet based on the food level system may be performed by the food level categorizer 60.

At step 805, the food level categorizer 60 may receive information pertaining to the health condition of a patient. The health condition information may include biometric information such as the patient's age, weight and height. The health condition information may also include any diseases or illnesses that may be affecting the patient and any medical or surgical therapies that may be required in the future for the patient.

At step 810, the food level categorizer 60 may determine whether the patient's health, wellness and fitness are optimal for his age. In one implementation, the food level categorizer 60 may make this determination based on conventional medical analysis. The patient's health, wellness and fitness may be considered to be optimal when the patient's health condition has no abnormalities on physical exam, blood analysis or imaging studies. Imaging studies may include a CT Scan, X ray, MRI, EKG, EEG, and the like. If the food level categorizer 60 determines that the patient's health, wellness and fitness are optimal for his age, the food level categorizer 60 may proceed to step 815. At step 815, the food level categorizer 60 may prescribe the patient a diet consisting of foods that are categorized between Food Level 0 and Food Level 6. Examples of patients whose health, wellness and fitness are optimal for their ages may include a high school aged competitive athlete without any known medical problems and having an excellent level of fitness or an adult professional athlete without any medical problems, having a normal physical exam, and with good eating habits.

Referring back to step 810, if the food level categorizer 60 determines that the patient's health, wellness and fitness are not optimal for his age, the food level categorizer 60 may proceed to step 820. At step 820, the food level categorizer 60 may determine whether the patient's health has abnormalities on physical exam, blood analysis or imaging studies but does not require any medical or surgical therapies. Medical or surgical therapies may include medications, acupuncture, surgeries, or any other type of therapy designed to improve the patient's health. If the food level categorizer 60 determines that the patient's health has abnormalities on physical exam, blood analysis or imaging studies but does not require any medical or surgical therapies, the food level categorizer 60 may proceed to step 825.

At step 825, the food level categorizer 60 may prescribe the patient a diet that initially consists of foods in Food Levels 0-3 and then prescribe a diet that consists of foods in Food Levels 0-6. In one implementation, the food level categorizer 60 may include Food Levels 4-6 in the patient's prescribed diet only after the patient shows a percentage improvement in his health condition that exceeds a predetermined value. The percentage improvement in the patient's health may be based on his initial health condition. Examples of patients whose health has abnormalities on physical exam, blood analysis or imaging studies but does not require any medical or surgical therapies may include a weekend jogger with borderline elevated blood pressure and no other problems, or a young mother of an infant with prior history of a mildly elevated blood sugar during her pregnancy.

Referring back to step 820, if the food level categorizer 60 determines that the patient's health has abnormalities on physical exam, blood analysis or imaging studies and requires medical or surgical therapies, the food level categorizer 60 may proceed to step 830. At step 830, the food level categorizer 60 may determine whether the patient's health is chronic, stable or slowly declining such that it may require medical or surgical therapies. Chronic, stable or slowly declining health such that it may require medical or surgical therapies may include when the patient's health has abnormalities on physical exam, blood analysis, or imaging studies and requires one or more fixed therapies within a period of 6 to 12 months. Fixed therapies may include therapies provided at regular intervals during a period of 6 to 12 months. If the food level categorizer 60 determines that the patient's health is chronic, stable or slowly declining such that it may require medical or surgical therapies, the food level categorizer 60 may proceed to step 835.

At step 835, the food level categorizer 60 may prescribe the patient a diet that initially consists of foods in Food Levels 0-3 and then prescribe a diet that consists of foods in Food Levels 0-6. If the patient's condition does not improve, the food level categorizer 60 may then prescribe a diet that consists of foods in Food Levels 0-3 again. In one implementation, the food level categorizer 60 may include Food Levels 4-6 in the patient's prescribed diet only after the patient shows a percentage improvement in his health condition that exceeds a predetermined value. Examples of patients whose health is chronic, stable or slowly declining such that it may require medical or surgical therapy may include a 45-year-old woman with diabetes and high blood pressure requiring an increase in her medications, or a 50-year-old man with high cholesterol and increasing fatigue over the past year.

Referring back to step 830, if the food level categorizer 60 determines that the patient's health is worse than chronic, stable or slowly declining, the food level categorizer 60 may proceed to step 840. At step 840, the food level categorizer 60 may determine whether the patient's health is chronic and moderately declining such that it may require medical or surgical therapies. Chronic and moderately declining health such that it may require medical or surgical therapies may include when the patient's health has abnormalities on physical exam, blood analysis, or imaging studies and requires an increase in one or more therapies within a period of 6 months. An increase in the therapies may include an increase in a dosage of medication, in intensity for treatment and the like. If the food level categorizer 60 determines that the patient's health is chronic and moderately declining such that it may require medical or surgical therapies, the food level categorizer 60 may proceed to step 845.

At step 845, the food level categorizer 60 may prescribe the patient a diet that initially consists of foods in Food Levels 0-3 and then prescribe a diet that consists of foods in Food Levels 0-4. In one implementation, the food level categorizer 60 may include Food Level 4 in the patient's prescribed diet only after the patient shows a percentage improvement in his health condition that exceeds a predetermined value. Examples of patients whose health is chronic and moderately declining such that it may require medical or surgical therapies may include a 63-year-old retired executive with recurrence of chest discomfort 6 years after undergoing 4 vessel coronary artery bypass surgery requiring the placement of two coronary artery stents in his heart, or a 55-year-old woman with a known condition of congestive heart failure, being seen by her cardiologist for worsening shortness of breath and being admitted to the hospital for intravenous heart failure medications and an implantable defibrillator.

Referring back to step 840, if the food level categorizer 60 determines that the patient's health is worse than chronic and moderately declining, the food level categorizer 60 may proceed to step 850. At step 850, the food level categorizer 60 may determine whether the patient's health includes acute decomposition of a chronic illness with rapidly declining health requiring urgent or emergency medical or surgical therapies. If the food level categorizer 60 determines that the patient's health includes acute decomposition of a chronic illness with rapidly declining health requiring urgent or emergency medical or surgical therapies, the food level categorizer 60 may proceed to step 855.

At step 855, the food level categorizer 60 may prescribe the patient a diet that initially consists of foods in Food Levels 0 until the illness stabilizes and then prescribe a diet that consists of foods in Food Levels 0-3. Examples of patients whose health includes acute decomposition of a chronic illness with rapidly declining health requiring urgent or emergency medical or surgical therapies may include a 45-year-old man with known diabetes, high blood pressure, and severely elevated cholesterol who is being rushed to the emergency department for sudden onset of severe chest discomfort, sweatiness and shortness of breath, or a 49-year-old woman with known hypertension, diabetes and heart failure being rushed to the emergency department and being placed on an artificial ventilator for acute shortness of breath due to the buildup of fluid in her lungs.

In one implementation, the diets prescribed by the food level categorizer 60 may be used to facilitate the healing process of a patient based on the foods' ability to allow for optimal human bodily healing or function. As mentioned above, foods in the lower levels are potentially more nourishing or healing than foods in the higher levels. As such, the food level categorizer 60 may focus on prescribing lower Food Levels for a patient with declining health.

An example of how the food level categorizer 60 may prescribe a diet to a patient is provided below. At step 805, the food level categorizer 60 may receive information pertaining to a patient's health. In one implementation, the information may include the patient's baseline nutritional history. The patient's baseline nutritional history may reveal that the patient consumes 85% of her foods within food levels 8-10, 10% in level 7 and the remainder in levels 0-6. The information may also include the patient's medical history and clinical condition. By analyzing the information, the food level categorizer 60 may determine (steps 810-850) that the patient's health includes an advance illness and her health condition is rapidly declining. Based on this determination, the food level categorizer 60 may prescribe foods in Food Levels 0-3. In one implementation, the patient may have a ventilator attached to her which may prevent her from being able to chew. In this case, the food level categorizer 60 may prescribe the patient a diet consisting of Food Level 0 exclusively. In one implementation, if the patient's health information includes diabetes and insulin resistance, the food level categorizer 60 may prescribe foods in level 0 except for foods in level 0—Food Factor 3C (i.e., the high glycemic index category).

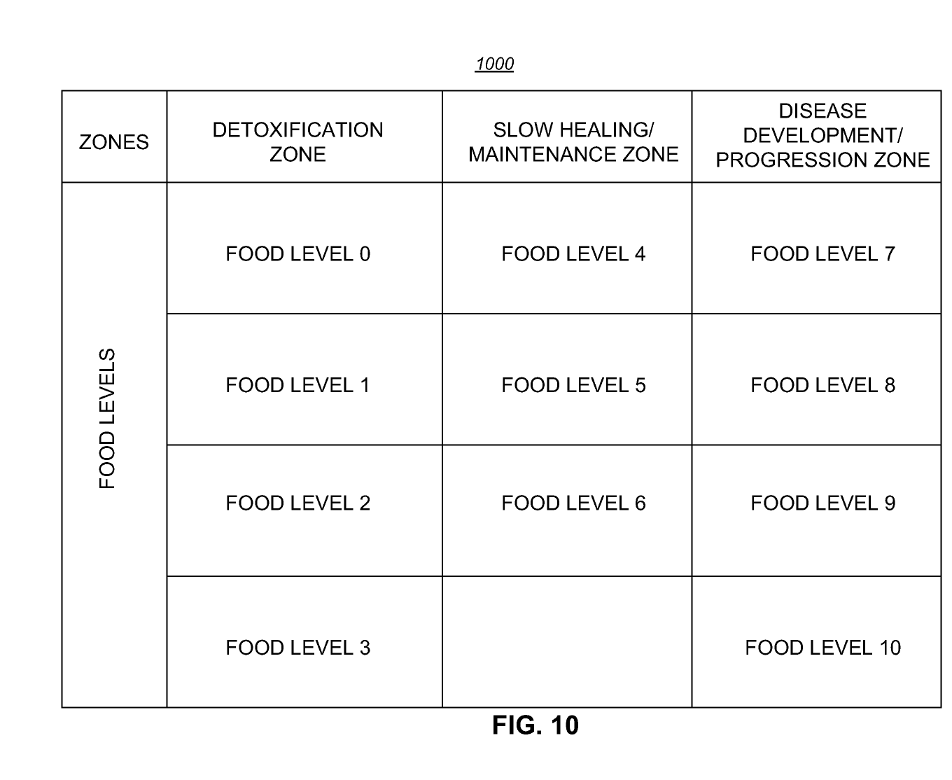

FIG. 9 illustrates a flow diagram of a method for displaying a list of foods, recipes and food plans that correspond to a food level in accordance with one or more implementations of various techniques described herein. The following description of method 900 is made with reference to computing system 100 of FIG. 1 and the food level system 700 in FIG. 7. It should be understood that while the operational flow diagram indicates a particular order of execution of the operations, in some implementations, certain portions of the operations might be executed in a different order. In one implementation, method 900 for prescribing a diet based on the food level system may be performed by the food level categorizer 60.

At step 910, the food level categorizer 60 may receive a Food Level number. At step 920, the food level categorizer 60 may identify foods, recipes and food plans that correspond to the Food Level number received at step 910. In one implementation, the computer system 100 may store lists of foods, recipes and food plans in the system memory 22, the database system 55 or the like. After identifying foods, recipes and food plans that correspond to the Food Level number received at step 910, the food level categorizer 60 may display the identified foods, recipes and food plans at step 930. In one implementation, the food level categorizer 60 may display the identified foods, recipes and food plans on the monitor 47 or output the identified foods, recipes and food plans to a peripheral output device such as a printer.

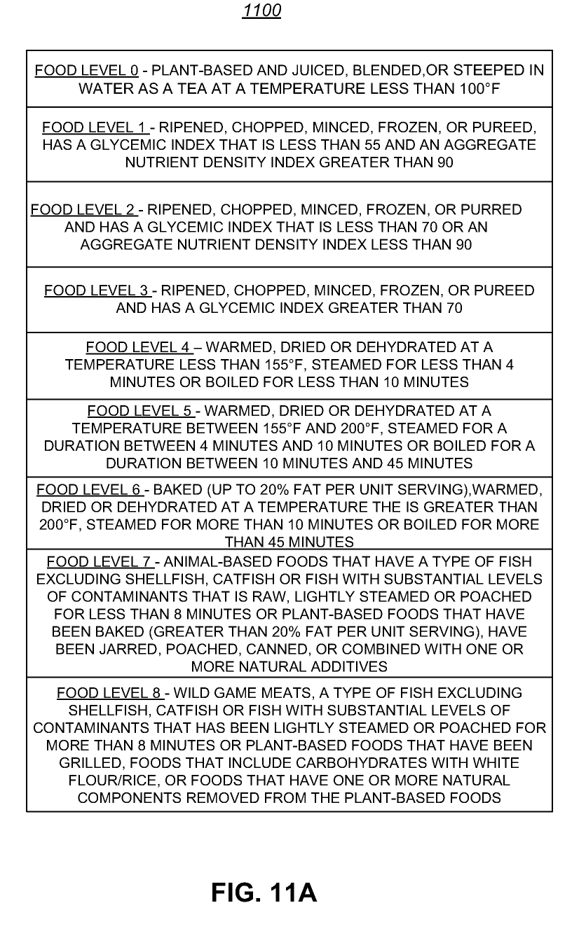

FIG. 10 illustrates a chart indicating food levels and its corresponding health zones in accordance with one or more implementations of various techniques described herein. The following description of chart 1000 is made with reference to the food level system 700 in FIG. 7. In one implementation, the food levels in the food level system 700 may be categorized into three separate health zones: a detoxification zone, a slow healing/maintenance zone, or a disease development/progression zone. The detoxification zone allows for maximal physiological and anatomical healing and disease reversal. The slow healing or maintenance zone allows the body to stabilize its current condition with the potential for slow, gradual improvement. The disease development or progression zone allows for the build-up of toxins in the body that potentiates cell death, accelerated aging, progressive disease states and premature death. The various food levels are grouped into the three basic zones as shown in FIG. 10. The detoxification zone includes foods in Food Levels 0-3, the slow healing or maintenance zone includes foods in Food Levels 4-6, and the disease development or progression zone includes foods in Food Levels 7-10.

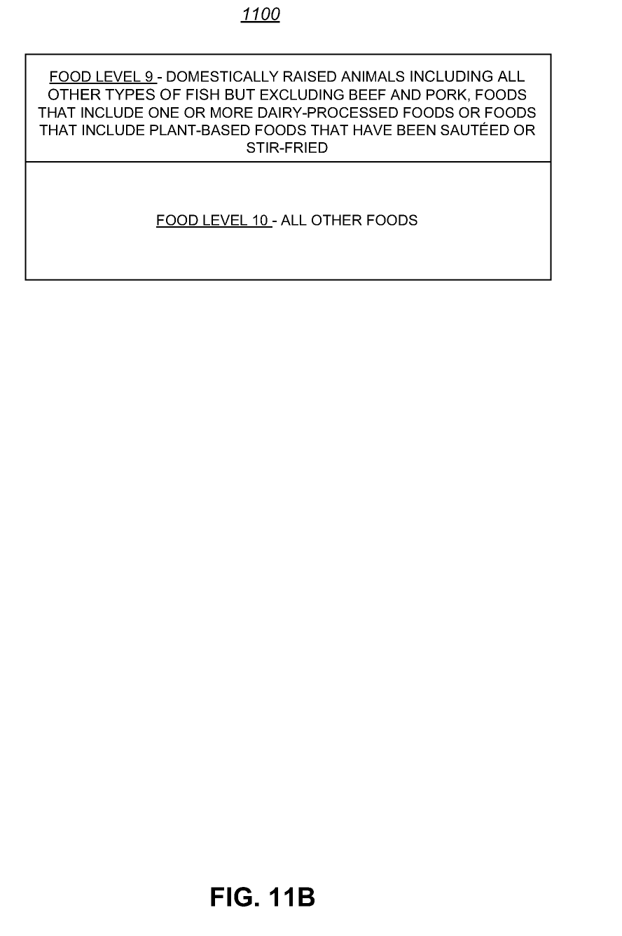

FIG. 11A-11B illustrate a schematic diagram of a data structure 1100 for a food level system in accordance with implementations of various technologies and techniques described herein. The following description of data structure 1100 is made with reference to computing system 100 of FIG. 1 and method 300 in FIG. 3. In one implementation, data structure 1100 may be stored in the system memory 22, database system 55 or the like. Each Food Level in data structure 1100 stores foods that correspond to its Food Level as described in method 300.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of categorizing a food, comprising:
receiving a description of the food;
determining whether the food is plant-based or animal-based;
determining an extent in which the food is processed;
determining one or more nutritional characteristics of the food; and
categorizing the food to a food level between 0 and 10 based on whether the food is plant-based or animal-based, the extent of processing and the nutritional characteristics.

2. The method of claim 1, further comprising determining an origin of the food, wherein the origin of the food describes whether the food was developed in wild conditions, naturally cultivated, or unnaturally cultivated.

3. The method of claim 1, further comprising receiving information about whether the food is plant-based or animal-based, the extent of processing and the nutritional characteristics.

4. The method of claim 1, further comprising determining whether the food is synthetic and taking into account whether the food is synthetic in categorizing the food.

5. The method of claim 1, further comprising displaying the food level as a number.

6. The method of claim 1, wherein the extent of processing is based on two categories: A) processing that causes a physical and/or chemical change to the food; or B) processing that causes mixing or combining the food with other substances.

7. The method of claim 1, wherein the nutritional characteristics is based on five sublevels: 1) Glycemic Index of the food; 2) Nutrient Density of the food; 3) Phytonutrient, Vitamin and Mineral Content of the food; 4) Glycemic Load of the food; or 5) Macromolecular Profile of the food.

8. The method of claim 1, wherein categorizing the food comprises:
categorizing the food in Food Level 0 if the food is plant-based and juiced, blended, or steeped in water as a tea at a temperature less than 100° F.;
categorizing the food in Food Level 1, 2 or 3 if the food is ripened, chopped, minced, frozen, or pureed;
categorizing the food in Food Level 4 if the food is warmed, dried or dehydrated at a temperature less than 155° F., steamed for less than 4 minutes or boiled for less than 10 minutes;
categorizing the food in Food Level 5 if the food is warmed, dried or dehydrated at a temperature between 155° F. and 200° F., steamed for a duration between 4 minutes and 10 minutes or boiled for a duration between 10 minutes and 45 minutes;
categorizing the food in Food Level 6 if the food is baked and have up to 20% fat per unit serving, if the food is warmed, dried or dehydrated at a temperature the is greater than 200° F., steamed for more than 10 minutes or boiled for more than 45 minutes;
categorizing the food in Food Level 7 if the food is an animal-based food that is a type of fish excluding shellfish, catfish or fish with substantial levels of contaminants that is raw, lightly steamed or poached for less than 8 minutes or a plant-based food that has been baked and has greater than 20% fat per unit serving, has been jarred, poached, canned, or combined with one or more natural additives;
categorizing the food in Food Level 8 if the food is an animal-based food that is a wild game meat, a type of fish excluding shellfish, catfish or fish with substantial levels of contaminants that has been lightly steamed or poached for more than 8 minutes or a plant-based food that has been grilled, includes carbohydrates with white flour/rice, or has one or more natural components removed from the plant-based food;
categorizing the food in Food Level 9 if the food includes domestically raised animals excluding beef and pork, all other types of fish, or one or more dairy-processed foods or includes plant-based foods that have been sautéed or stir-fried; and
categorizing the food in Food Level 10 if the food is not categorized in any other Food Level.

9. The method of claim 8, wherein categorizing the food in Food Level 1, 2 or 3 comprises:
categorizing the food in Food Level 1 if the food has a glycemic index that is less than 55 and an aggregate nutrient density index greater than 90;
categorizing the food in Food Level 2 if the food has a glycemic index that is less than 70 or an aggregate nutrient density index less than 90; and
categorizing the food in Food Level 3 if the food has a glycemic index greater than 70.

10. A method of categorizing a food, comprising:
receiving a description of the food;
receiving information about whether the food is plant-based or animal-based;
receiving information about an extent in which the food is processed;
receiving information about one or more nutritional characteristics of the food; and
categorizing the food to a food level between 0 and 10 based on whether the food is plant-based or animal-based, the extent of processing and the nutritional characteristics.

11. A method for displaying a list of foods that corresponds to a food level, comprising:
receiving the food level;
determining a list of foods, recipes, meal plans, or combinations thereof that correspond to the food level; and
displaying the list.

12. The method of claim 11, wherein the food level is based on whether the food is plant-based or animal-based, an extent in which the food is processed and one or more nutritional characteristics of the food.

13. The method of claim 11, wherein determining the list comprises identifying a plurality of foods, recipes and meal plans from a database that categorizes the plurality according to its corresponding food level.

14. A method for prescribing a diet for a patient, comprising:
receiving a health condition of the patient;
determining one or more food levels for the diet based on the health condition; and
displaying the diet.

15. The method of claim 14, wherein the health condition includes biometric information pertaining to the patient, one or more illnesses affecting the patient, one or more therapies for the patient, or combinations thereof.

16. The method of claim 14, wherein the food levels comprise:
Food Level 0 for one or more foods that are plant-based and juiced, blended or steeped in water as a tea at a temperature less than 100° F.;
Food Level 1 for one or more foods that are ripened, chopped, minced, frozen, or pureed, have a glycemic index that is less than 55 and has an aggregate nutrient density index greater than 90;
Food Level 2 for one or more foods that are ripened, chopped, minced, frozen, or pureed, and have a glycemic index that is less than 70 or an aggregate nutrient density index less than 90;
Food Level 3 for one or more foods that are ripened, chopped, minced, frozen, or pureed and have a glycemic index greater than 70;
Food Level 4 for one or more foods that are warmed, dried or dehydrated at a temperature less than 155° F., steamed for less than 4 minutes or boiled for less than 10 minutes;
Food Level 5 for one or more foods that are warmed, dried or dehydrated at a temperature between 155° F. and 200° F., steamed for a duration between 4 minutes and 10 minutes or boiled for duration between 10 minutes and 45 minutes; and
Food Level 6 for one or more foods that are baked and have up to 20% fat per unit serving, are warmed, dried or dehydrated at a temperature that is greater than 200° F., steamed for more than 10 minutes or boiled for more than 45 minutes.

17. The method of claim 16, wherein the diet comprises one or more foods from Food Levels 0-6 when the patient's health condition has no abnormalities on physical exam, blood analysis or imaging studies.

18. The method of claim 16, wherein the diet comprises:
one or more foods from Food Levels 0-3 when the health condition has abnormalities on physical exam, blood analysis, or imaging studies but does not require one or more therapies; and
one or more food from Food Levels 0-6 when the health condition shows a percentage improvement in the health condition that exceeds a predetermined value.

19. The method of claim 16, wherein the diet comprises:
one or more foods from Food Levels 0-3 when the health condition has abnormalities on physical exam, blood analysis, or imaging studies and requires one or more fixed therapies within a period of 6 to 12 months;
one or more food from Food Levels 0-6 when the health condition shows a percentage improvement in the health condition that exceeds a predetermined value; and
one or more food from Food Levels 0-3 if the health condition does not improve.

20. The method of claim 16, wherein the diet comprises:
one or more foods from Food Levels 0-3 when the health condition has abnormalities on physical exam, blood analysis, or imaging studies and requires an increase in one or more therapies within a period of 6 months; and
one or more food from Food Levels 0-4 when the health condition shows a percentage improvement in the health condition that exceeds a predetermined value.

21. The method of claim 16, wherein the diet comprises one or more foods from Food Levels 0-3 when the health condition has abnormalities on physical exam, blood analysis, or imaging studies and requires one or more urgent or emergency therapies.

22. A memory for storing data for access by a computer application being executed on a processor, the memory comprising:
a data structure stored in the memory, the data structure comprising:
a category level zero for foods that are plant-based and juiced, blended, or steeped in water as a tea at a temperature less than 100° F.;
a category level one for foods that are ripened, chopped, minced, frozen, or pureed, have a glycemic index that is less than 55 and an aggregate nutrient density index greater than 90;
a category level two for foods that are ripened, chopped, minced, frozen, or pureed and have a glycemic index that is less than 70 or an aggregate nutrient density index less than 90;
a category level three for foods that are ripened, chopped, minced, frozen, or pureed and have a glycemic index greater than 70;
a category level four for foods that are warmed, dried or dehydrated at a temperature less than 155° F., steamed for less than 4 minutes or boiled for less than 10 minutes;
a category level five for foods that are warmed, dried or dehydrated at a temperature between 155° F. and 200° F., steamed for a duration between 4 minutes and 10 minutes or boiled for a duration between 10 minutes and 45 minutes;
a category level six for foods that are baked and have up to 20% fat per unit serving, warmed, dried or dehydrated at a temperature the is greater than 200° F., steamed for more than 10 minutes or boiled for more than 45 minutes;
a category level seven for foods that are animal-based foods that have a type of fish excluding shellfish, catfish or fish with substantial levels of contaminants that is raw, lightly steamed or poached for less than 8 minutes or plant-based foods that have been baked and have greater than 20% fat per unit serving, have been jarred, poached, canned, or combined with one or more natural additives;
a category level eight for foods that are wild game meats, a type of fish excluding shellfish, catfish or fish with substantial levels of contaminants that has been lightly steamed or poached for more than 8 minutes or plant-based foods that have been grilled, foods that include carbohydrates with white flour/rice, or foods that have one or more natural components removed from the plant-based foods;
a category level nine for foods that are domestically raised animals including all other types of fish but excluding beef and pork, foods that include one or more dairy-processed foods or foods that include plant-based foods that have been sautéed or stir-fried; and
a category level ten for all other foods.

23. The memory of claim 22, wherein the category level zero, the category level one, the category level two and the category level three are part of a detoxification zone.

24. The memory of claim 23, wherein the detoxification zone allows for physiological and anatomical healing and disease reversal.

25. The memory of claim 22, wherein the category level four, the category level five, the category level six are part of a maintenance zone.

26. The memory of claim 25, wherein the maintenance zone allows a body to stabilize its current condition with a potential for improvement.

27. The memory of claim 22, wherein the category level seven, the category level eight, the category level nine and the category level ten are part of a disease development or progression zone.

28. The memory of claim 27, wherein the disease development or progression zone allows for a build-up of toxins in a body that potentiates cell death, accelerated aging, progressive disease states and premature death.
